(19) United States
(12) Patent Application Publication
(10) Pub. No.: US 2007/0007268 A1
(43) Pub. Date: Jan. 11, 2007

(54) APPARATUS FOR PLACING THERMOPLASTIC DECORATION

(75) Inventor: Jan-Nan Chen, Taichung (TW)

Correspondence Address: NIKOLAI & MERSEREAU, P.A., 900 SECOND AVENUE SOUTH, SUITE 820, MINNEAPOLIS, MN, 55402, US

(73) Assignee: ARLO LIN, Tortola (VG)

(21) Appl. No.: 11/162,773

(22) Filed: Sep. 22, 2005

(30) Foreign Application Priority Data
Jul. 8, 2005 (TW) 94123089

(51) Int. Cl. H05B 3/02; H05B 1/00; B30B 15/34

(52) U.S. Cl. 219/243; 156/583.1

(57) ABSTRACT

There is disclosed an apparatus for placing a thermoplastic decoration onto clothes. The apparatus includes a handle, an iron connected to the handle and a pusher connected to the iron. The iron includes a heating tube for receiving and heating the thermoplastic decoration. The pusher can push the thermoplastic decoration from the heating tube.

### BACKGROUND OF INVENTION

1. Field of Invention

The present invention relates to a thermoplastic decoration and, more particularly, to an apparatus for placing a thermoplastic decoration.

2. Related Prior Art

Referring to FIG. 8, there is shown a conventional apparatus 100 for placing a thermoplastic decoration 200. The apparatus 100 includes a handle 110 and an iron 120. An end of the iron 120 is attached to the handle 110. At the other end of the iron 120 is formed a heating tube 121. Connected to a power supply (not shown), the iron 120 can produce heat that will be conducted to the heating tube 121.

In use, the thermoplastic decoration 200 is put in the heating tube 121. The heating tube 121 is moved to a desired place on clothes 300. The thermoplastic decoration 200 is heated in the heating tube 121. The thermoplastic decoration 200 melts and sticks to the clothes 300.

Referring to FIG. 9, the thermoplastic decoration 200 not only adheres to the clothes 300 but also adheres to the heating tube 121. That is, the apparatus 100, the thermoplastic decoration 200 and the clothes 300 adhere to one another. Hence, while lifting the apparatus 100 in order to leave the thermoplastic decoration 200 on the clothes 300, a user might lift all of them. To avoid this, the user has to hold the clothes 300 with one hand and lift the apparatus 100 with the other hand. When the adhesion of the thermoplastic decoration 200 to the heating tube 121 is stronger than the adhesion of the thermoplastic decoration 200 to the clothes 300, the thermoplastic decoration 200 will adhere to the heating tube 121, not the clothes 300. Only when the adhesion of the thermoplastic decoration 200 to the heating tube 121 is weaker than the adhesion of the thermoplastic decoration 200 to the clothes 300, the thermoplastic decoration 200 will adhere to the clothes 300, not the heating tube 121. The user might have to try several times before placing the thermoplastic decoration 200 on the clothes 300.

The present invention is therefore intended to obviate or at least alleviate the problems encountered in prior art.

### SUMMARY OF INVENTION

According to the present invention, there is disclosed an apparatus for placing a thermoplastic decoration onto clothes. The apparatus includes a handle, an iron connected to the handle and a pusher connected to the iron. The iron includes a heating tube for receiving and heating the thermoplastic decoration. The pusher can push the thermoplastic decoration from the heating tube.

An advantage of the apparatus according to the present invention is its easy and convenient operation.

Other advantages and novel features of the invention will become more apparent from the following detailed description in conjunction with the drawings.

### BRIEF DESCRIPTION OF DRAWINGS

The present invention will be described through detailed illustration of two embodiments referring to the drawings.

FIG. 1 is a perspective view of an apparatus for placing a thermoplastic decoration according to the first embodiment of the present invention.

FIG. 2 is an exploded view of the apparatus shown in FIG. 1.

FIG. 3 is a partially cross-sectional view of the apparatus shown in FIG. 1.

FIGS. 4 and 5 are partially cross-sectional views of the apparatus shown in FIG. 1 in various steps of an operation.

FIG. 6 is a partially cross-sectional view of an apparatus for placing a thermoplastic decoration according to the first embodiment of the present invention.

FIG. 7 is similar to FIG. 6 but shows the apparatus in a different step of an operation.

FIG. 8 is a partially cross-sectional view of a conventional apparatus for placing a thermoplastic decoration.

FIG. 9 is similar to FIG. 8 but shows the apparatus in a different step of an operation.

### DETAILED DESCRIPTION OF EMBODIMENTS

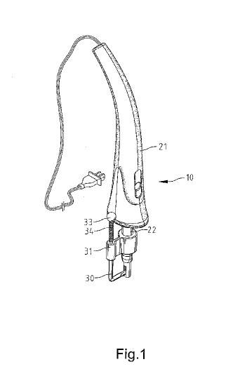

Referring to FIG. 1, there is shown an apparatus 10 for placing a thermoplastic decoration 40 according to a first embodiment of the present invention. The apparatus 10 includes a handle 21, an iron 22 and a pusher 30.

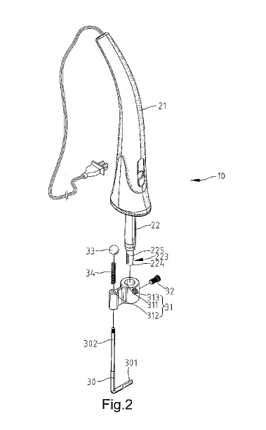

Referring to FIG. 2, an end of the iron 22 is put in and attached to the handle 21. At the other end of the iron 22 is formed a heating tube 223. Connected to a power supply (not shown) through a wire (not numbered), the iron 22 can generate heat that will be conducted to the heating tube 223. The heating tube 223 includes an opening 224 at the tip and a slit 225 in communication with the space in the heating tube 223.

The pusher 30 includes a pushing portion 301 and a sliding portion 302 extending from the pushing portion 301 at the right angle. Thus, the pusher 30 is L-shaped.

The pusher 30 is connected to the iron 22 by means of a connector 31. The connector 31 defines a first tunnel 311, a second tunnel 312 parallel to the first tunnel 311 and a screw hole 313 in communication with the first tunnel 311.

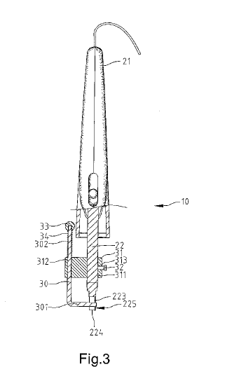

Referring to FIG. 3, in assembly, the iron 22 is inserted in the first tunnel 311 so that the heating tube 223 is put beyond the first tunnel 311. A screw 32 is driven into the screw hole 313. Extending beyond the screw hole 313, the tip of the screw 32 abuts the iron 22. Thus, the connector 31 is attached to the iron 22. The sliding portion 302 is inserted through the second tunnel 312, and the pushing portion 301 is put in the heating tube 223 through the slit 225.

A helical compression spring 34 is put around the pushing portion 301. A button 33 is attached to the pushing portion 301. The sliding portion 302 is preferably formed with a thread (not numbered). The button 33 is preferably a ball defining a screw hole (not numbered) for engagement with the thread of the sliding portion 302. A user can push the button 33 in order to move the pusher 30 relative to the iron 22. At this instant, the compression spring 34 is compressed between the button 33 and the connector 31. As soon as the user releases the button 33, the compression spring 34 will return the pusher 30.

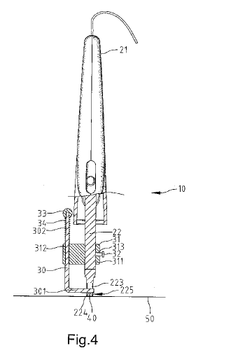

Referring to FIG. 4, the thermoplastic decoration 40 is put in the heating tube 223 through the opening 224. The heating tube 223 is moved to a position on clothes 50 so that the thermoplastic decoration 40 is in contact with the clothes 50. The thermoplastic decoration 40 is heated in the heating tube 223. The thermoplastic decoration 40 melts and adheres to the clothes 50.

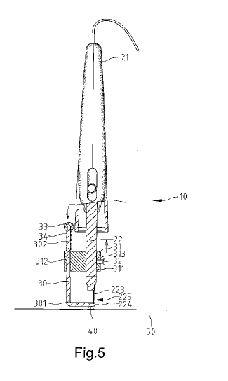

Referring to FIG. 5, when the thermoplastic decoration 40 adheres to the clothes 50, the button 33 is pushed so that the thermoplastic decoration 40 is pushed from the heating tube 223 through the opening 224 by means of the pushing portion 301. At this instant, the compression spring 34 is compressed. When the thermoplastic decoration 40 is outside the heating tube 223, the button 33 is released. The compression spring 34 recovers abruptly, thus moving the pushing portion 301 from the thermoplastic decoration 40.

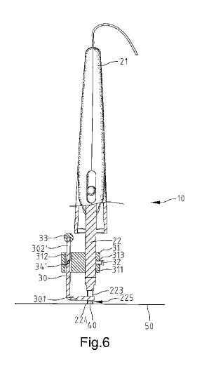

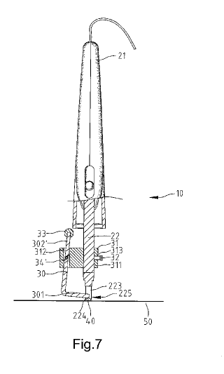

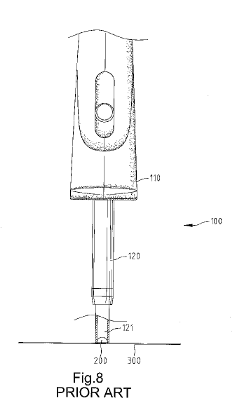

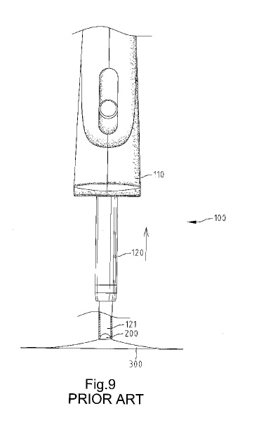

Referring to FIGS. 6 and 7, there is shown an apparatus 10 for placing the thermoplastic decoration 40 according to a second embodiment of the present invention. The second embodiment is identical to the first embodiment except a few things. Firstly, the pusher 30 includes a pivoting portion 302′ pivotally put in the second tunnel 312 instead of the sliding portion 302 put in the second tunnel 312 in the sliding manner. To this end, the diameter of the pivoting portion 302′ must be smaller than that of the second tunnel 312. Secondly, a toque spring 34′ is used instead of the compression spring 34.

In use, the button 33 is pushed so that the thermoplastic decoration 40 is pushed from the heating tube 223 through the opening 224 by means of the pushing portion 301. Now, the torque spring 34′ is loaded. When the thermoplastic decoration 40 is outside the heating tube 223, the button 33 is released. The torque spring 34′ recovers abruptly, thus moving the pushing portion 301 from the thermoplastic decoration 40.

The apparatus 10 of the present invention exhibits several advantages. Firstly, the pusher 30 can push the thermoplastic decoration 40 from the heating tube 223 through the opening 224 so that the thermoplastic decoration 40 does not adhere to the heating tube 223. The spring can move the pusher 30 from the thermoplastic decoration 40 abruptly.

Secondly, the structure of the apparatus 10 is simple. The operation of the apparatus 10 is easy and convenient.

The present invention has been described through the detailed illustration of the embodiments. Those skilled in the art can derive variations from the embodiments without departing from the scope of the present invention. Therefore, the embodiments shall not limit the scope of the present invention defined in the claims.

What is claimed is:

1. An apparatus for placing a thermoplastic decoration, the apparatus comprising:
an iron comprising a heating tube for receiving and heating the thermoplastic decoration; and
a pusher for pushing the thermoplastic decoration from the heating tube.

2. The apparatus according to claim 1 comprising a handle connected to the iron.

3. The apparatus according to claim 1 wherein the pusher comprises a pushing portion entering the heating tube for pushing the thermoplastic decoration.

4. The apparatus according to claim 3 wherein the heating tube defines a slit through which the pushing portion enters the heating tube.

5. The apparatus according to claim 3 wherein the pusher comprises a sliding portion extending from the pushing portion for sliding parallel to the heating tube.

6. The apparatus according to claim 5 comprising a button attached to the sliding portion for facilitating the sliding of the sliding portion.

7. The apparatus according to claim 5 comprising a connector for connecting the sliding portion to the heating tube.

8. The apparatus according to claim 7 wherein the connector defines a first tunnel for receiving the heating tube and a second tunnel for receiving the sliding portion.

9. The apparatus according to claim 8 wherein the connector defines a screw hole through which a screw is driven for securing the connector to the heating tube.

10. The apparatus according to claim 5 comprising a spring compressed between the sliding portion and the connector.

11. The apparatus according to claim 3 wherein the pusher comprises a pivoting portion extending from the pushing portion pivoting on the heating tube.

12. The apparatus according to claim 111 comprising a button attached to the pivoting portion for facilitating the pivoting of the pivoting portion.

13. The apparatus according to claim 111 comprising a connector for connecting the pivoting portion to the heating tube.

14. The apparatus according to claim 13 wherein the connector defines a first tunnel for receiving the heating tube and a second tunnel for receiving the pivoting portion.

15. The apparatus according to claim 14 wherein the connector defines a screw hole through which a screw is driven for securing the connector to the heating tube.

16. The apparatus according to claim 111 comprising a torque spring provided between the pivoting portion and the connector.
